(19) United States
(12) Patent Application Publication
(10) Pub. No.: US 2026/0212894 A1
(43) Pub. Date: Jul. 23, 2026

(54) VIDEO EDITING METHOD

(71) Applicant: Tencent Technology (Shenzhen) Company Limited, Shenzhen (CN)

(72) Inventors: Fei KUANG, Shenzhen (CN); Bing SU, Shenzhen (CN); Lei LI, Shenzhen (CN); Jie KUANG, Shenzhen (CN); Lijing YIN, Shenzhen (CN)

(73) Assignee: Tencent Technology (Shenzhen) Company Limited, Shenzhen (CN)

(21) Appl. No.: 19/577,337

(22) Filed: Mar. 24, 2026

Related U.S. Application Data
(63) Continuation of application No. PCT/CN2024/118468, filed on Sep. 12, 2024.

(30) Foreign Application Priority Data
Dec. 7, 2023 (CN) 202311685731.X

(51) Int. Cl. G11B 27/031; G06F 3/04847; G06F 40/166; G10L 21/003; G10L 25/57

(52) U.S. Cl. CPC G11B 27/031; G06F 3/04847; G06F 40/166; G10L 21/003; G10L 25/57

(57) ABSTRACT

In a video editing method, an editing interface includes visualized representations of a video track and a dubbing subtitle track. In the method, recording of a voice clip is started when a dubbing start operation is triggered in association with a first time point. In the method, the recording of the voice clip is stopped when a dubbing end operation is triggered in association with a second time point. In the method, the recorded voice clip is loaded into the dubbing subtitle track from the first time point to the second time point of the time progress of the dubbing subtitle track. In the method, a voice recognition text recognized from the voice clip is displayed in the editing interface. In the method, a fused video is generated based on a video editing completion operation, the fused video including the video, the voice clip, and the voice recognition text.

### RELATED APPLICATIONS

The present application is a continuation of International Application No. PCT/CN2024/118468, filed on September 12, 2024, which claims priority to Chinese Patent Application No. 202311685731.X, filed on December 7, 2023, and entitled "VIDEO EDITING METHOD AND APPARATUS, ELECTRONIC DEVICE, AND STORAGE MEDIUM." The entire disclosures of the prior applications are hereby incorporated by reference.

### FIELD OF THE TECHNOLOGY

This disclosure relates to the field of computers, including a video editing method and apparatus, an electronic device, and a storage medium.

### BACKGROUND OF THE DISCLOSURE

Video multiplexing refers to combining multimedia streams into one single video, for example, combining a video, audio, a subtitle, dubbing, and the like into one video. Current video multiplexing is based on a user manually importing these multimedia streams and adjusting a position at which each multimedia stream appears at a video time progress. For example, when setting a subtitle, the user may manually input the subtitle, and adjust time points at which the subtitle appears and disappears in a video. For example, when performing dubbing, the user may manually import an entire dubbing file and adjust a playback time of the dubbing in the video.

To reduce time consumed by the user for manually adding the subtitle, some existing editing software provides an automatic subtitle function. In some examples, a pre-prepared voice file is recognized by using a voice recognition technology, to obtain text content of the pre-prepared voice file as a subtitle, and then playback time of the subtitle in a video is adjusted in the editing software.

However, to incorporate the dubbing and the subtitle at proper positions in the video time progress, the user may adjust time points at which the dubbing and the subtitle correctly appear and disappear in the video. Therefore, the user may manually clip an entire voice file or voice text, and adjust a position at which each clip appears in the video time progress. These operations may usually be repeated for a plurality of times, so that a plurality of pieces of dubbing and a plurality of subtitles may be configured. Consequently, operation complexity of a current video editing method can be high, and the entire editing task may take a large amount of adjustment time.

### SUMMARY

Embodiments of this disclosure provide a video editing method and apparatus, an electronic device, and a storage medium, to reduce operation complexity of the video editing method.

An embodiment of this disclosure provides a video editing method. In the method, an editing interface is displayed on a display, the editing interface including visualized representations of a video track and a dubbing subtitle track. A time progress of the video track is aligned with a time progress of the dubbing subtitle track, and the video track includes a video. In the method, recording of a voice clip is started by processing circuitry when a dubbing start operation is triggered in association with a first time point of the time progress of the dubbing subtitle track. In the method, the recording of the voice clip is stopped by the processing circuitry when a dubbing end operation is triggered in association with a second time point of the time progress of the dubbing subtitle track. In the method, the recorded voice clip is loaded by processing circuitry into the dubbing subtitle track from the first time point to the second time point of the time progress of the dubbing subtitle track. In the method, a voice recognition text recognized from the voice clip is displayed in the editing interface. In the method, a fused video is generated by processing circuitry based on a video editing completion operation, the fused video including the video, the voice clip, and the voice recognition text. The voice clip is playable with a video segment from the first time point to the second time point in the fused video. A subtitle of the voice clip in the fused video includes the voice recognition text.

An embodiment of this disclosure provides a video editing apparatus including processing circuitry. The processing circuitry is configured to display, on a display, an editing interface, the editing interface including visualized representations of a video track and a dubbing subtitle track, a time progress of the video track being aligned with a time progress of the dubbing subtitle track, and the video track including a video. The processing circuitry is configured to start recording of a voice clip when a dubbing start operation is triggered in association with a first time point of the time progress of the dubbing subtitle track. The processing circuitry is configured to stop the recording of the voice clip when a dubbing end operation is triggered in association with a second time point of the time progress of the dubbing subtitle track. The processing circuitry is configured to load the recorded voice clip into the dubbing subtitle track from the first time point to the second time point of the time progress of the dubbing subtitle track. The processing circuitry is configured to display in the editing interface a voice recognition text recognized from the voice clip. The processing circuitry is configured to generate, based on a video editing completion operation, a fused video including the video, the voice clip, and the voice recognition text. The voice clip is playable with a video segment from the first time point to the second time point in the fused video. A subtitle of the voice clip in the fused video includes the voice recognition text.

An embodiment of this disclosure provides a non-transitory computer-readable storage medium storing instructions which, when executed by a processor, cause the processor to perform a video editing method. In the method, an editing interface is displayed on a display, the editing interface including visualized representations of a video track and a dubbing subtitle track. A time progress of the video track is aligned with a time progress of the dubbing subtitle track, and the video track includes a video. In the method, recording of a voice clip is started when a dubbing start operation is triggered in association with a first time point of the time progress of the dubbing subtitle track. In the method, the recording of the voice clip is stopped when a dubbing end operation is triggered in association with a second time point of the time progress of the dubbing subtitle track. In the method, the recorded voice clip is loaded into the dubbing subtitle track from the first time point to the second time point of the time progress of the dubbing subtitle track. In the method, a voice recognition text recognized from the voice clip is displayed in the editing interface. In the method, a fused video is generated based on a video editing completion operation, the fused video including the video, the voice clip, and the voice recognition text. The voice clip is playable with a video segment from the first time point to the second time point in the fused video. A subtitle of the voice clip in the fused video includes the voice recognition text.

An embodiment of this disclosure provides a video editing method, performed by a computer device, and the method including: displaying an editing interface, the editing interface including a multi-track region, the multi-track region including a video track and a dubbing subtitle track, a time progress of the video track being aligned with a time progress of the dubbing subtitle track, and the video track indicating a time progress of a video; starting, in response to a dubbing start operation triggered at a first time point, recording a voice clip at the first time point of the dubbing subtitle track; loading, in response to a dubbing end operation triggered at a second time point, a recorded voice clip from the first time point to the second time point of the dubbing subtitle track, and presenting a voice recognition text recognized from the voice clip; and generating, in response to a video editing completion operation, a fused video including the video, the voice clip, and the voice recognition text, the voice clip being configured for dubbing for a video segment from the first time point to the second time point in the fused video, and the voice recognition text being usable as a subtitle of the voice clip in the fused video.

An embodiment of this disclosure further provides a video editing apparatus, including: an interface unit, configured to display an editing interface, the editing interface including a multi-track region, the multi-track region including a video track and a dubbing subtitle track, a time progress of the video track being aligned with a time progress of the dubbing subtitle track, and the video track indicating a time progress of a video; a dubbing start unit, configured to start, in response to a dubbing start operation triggered at a first time point, recording a voice clip at the first time point of the dubbing subtitle track; a dubbing end unit, configured to load, in response to a dubbing end operation triggered at a second time point, a recorded voice clip from the first time point to the second time point of the dubbing subtitle track, and present a voice recognition text recognized from the voice clip; and a multiplexing unit, configured to generate, in response to a video editing completion operation, a fused video including the video, the voice clip, and the voice recognition text, the voice clip being configured for dubbing for a video segment from the first time point to the second time point in the fused video, and the voice recognition text being usable as a subtitle of the voice clip in the fused video.

An embodiment of this disclosure further provides an electronic device, including: a memory (e.g., including a non-transitory computer-readable storage medium) storing a plurality of instructions; and processing circuitry (e.g., a processor) loading the instructions from the memory to perform the operations of the video editing method according to the embodiment of this disclosure.

An embodiment of this disclosure further provides a non-transitory computer-readable storage medium, the non-transitory computer-readable storage medium storing a plurality of instructions, and the instructions being suitable to be loaded by processing circuitry (e.g., a processor), to perform the operations of the video editing method according to the embodiment of this disclosure.

An embodiment of this disclosure further provides a computer program product, including a plurality of instructions, the instructions being suitable to be loaded by processing circuitry (e.g., a processor), to perform the operations of the video editing method according to the embodiment of this disclosure.

Details of one or more embodiments of this disclosure are provided in the following accompanying drawings and descriptions.

### BRIEF DESCRIPTION OF THE DRAWINGS

To describe the technical solutions in one or more embodiments of this disclosure, the following briefly describes the accompanying drawings for describing one or more embodiments of this disclosure. The accompanying drawings in the following descriptions show merely some embodiments of this disclosure, and a person of ordinary skill in the art may derive other drawings from the following drawings.

FIG. 1 is a schematic diagram of a scenario of a video editing method according to an embodiment of this disclosure.

FIG. 2 is a schematic flowchart of a video editing method according to an embodiment of this disclosure.

FIG. 3 is a schematic diagram of an editing interface of a video editing method according to an embodiment of this disclosure.

FIG. 4 is a schematic diagram of starting recording of a video editing method according to an embodiment of this disclosure.

FIG. 5 is a schematic diagram of ending recording of a video editing method according to an embodiment of this disclosure.

FIG. 6 is a schematic diagram of a home page of a video editing method according to an embodiment of this disclosure.

FIG. 7 is a schematic diagram of recording of a video editing method according to an embodiment of this disclosure.

FIG. 8 is a schematic diagram of a subtitle of a video editing method according to an embodiment of this disclosure.

FIG. 9 is a schematic diagram of a prompt of a video editing method according to an embodiment of this disclosure.

FIG. 10 is a schematic diagram of a text of a video editing method according to an embodiment of this disclosure.

FIG. 11 is a schematic diagram of text modification of a video editing method according to an embodiment of this disclosure.

FIG. 12 is a schematic diagram of a structure of a video editing apparatus according to an embodiment of this disclosure.

FIG. 13 is a schematic diagram of a structure of an electronic device according to an embodiment of this disclosure.

### DESCRIPTION OF THE EMBODIMENTS

The following describes the technical solutions in one or more embodiments of this disclosure with reference to the accompanying drawings in this disclosure. The described embodiments are some non-limiting embodiments of this disclosure rather than all of the embodiments. Other embodiments may fall within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

One or more embodiments of this disclosure provide a video editing method and apparatus, an electronic device, and a storage medium.

The video editing apparatus may be integrated into the electronic device, and the electronic device may be a device such as a terminal or a server. The terminal may be a device such as a mobile phone, a tablet computer, a smart Bluetooth device, a notebook computer, or a personal computer (PC). The server may correspond to a single server, or may correspond to a server cluster including a plurality of servers.

In some embodiments, the video editing apparatus may be integrated into a plurality of electronic devices. For example, the video editing apparatus may be integrated into the plurality of servers, and the plurality of servers is configured to implement the video editing method of this disclosure.

In some embodiments, the server may be implemented in a form of the terminal.

In some embodiments, the electronic device may be an intelligent terminal. In FIG. 1, a client of video editing software may be installed on an intelligent terminal, and the intelligent terminal may communicate with a server, and a server end of the video editing software may be installed on the server.

In some embodiments, the server relates to a cloud computing technology and a speech recognition technology. In some embodiments, the server may be a cloud server, and the server may convert, by using the speech recognition technology, recorded audio obtained from a client into a voice recognition text, and send the voice recognition text to the client.

For example, the client may display an editing interface, where the editing interface includes a multi-track region, the multi-track region includes visualized representations of a video track and a dubbing subtitle track, where a time progress of the video track is aligned with a time progress of the dubbing subtitle track, and the video track including a video. The client may start, in response to a dubbing start operation triggered at a first time point of the time progress of the dubbing subtitle track, recording of a voice clip. In some embodiments, an audio waveform graph calculated in real time may be displayed in the visualized representation of the dubbing subtitle track when the voice clip is being recorded. The client generates a voice clip in response to a dubbing end operation triggered at a second time point of the time progress of the dubbing subtitle track, and sends the voice clip to the server. In some embodiments, the server recognizes and returns a voice recognition text recognized from the voice clip In some embodiments, the voice clip is loaded into the dubbing subtitle track from the first time point to the second time point of the time progress of the dubbing subtitle track. In some embodiments, the voice recognition text is displayed in the editing interface along with the visualized representation of the voice clip. The client generates, in response to a video editing completion operation, a fused video including the video, the voice clip, and the voice recognition text, where the voice clip is for dubbing for the video segment from the first time point to the second time point in the fused video, and the voice recognition text is usable as a subtitle of the voice clip in the fused video.

In some embodiments, the client may split the voice recognition text into a plurality of sentences, determine a time range in which each sentence appears and disappears in a video time progress, and add each sentence paragraph at a corresponding time point of the video time progress according to the time range.

Detailed descriptions are separately provided below. The sequence numbers of the following embodiments are not intended to limit the disclosure. In one or more embodiments in this disclosure, a video track, an audio track, or a voice track may correspond to a data unit of a certain type handled; and an editing interface may include visualized representations of the video track, the audio track, or the voice track. In one or more embodiments in this disclosure, the visualized representation of a data unit (e.g., a video track, an audio track, or a voice track) may also be simply referred to as the data unit, provided the context is sufficiently clear whether such term is used to describe the data unit itself or the visualized representation of the data unit in the editing interface.

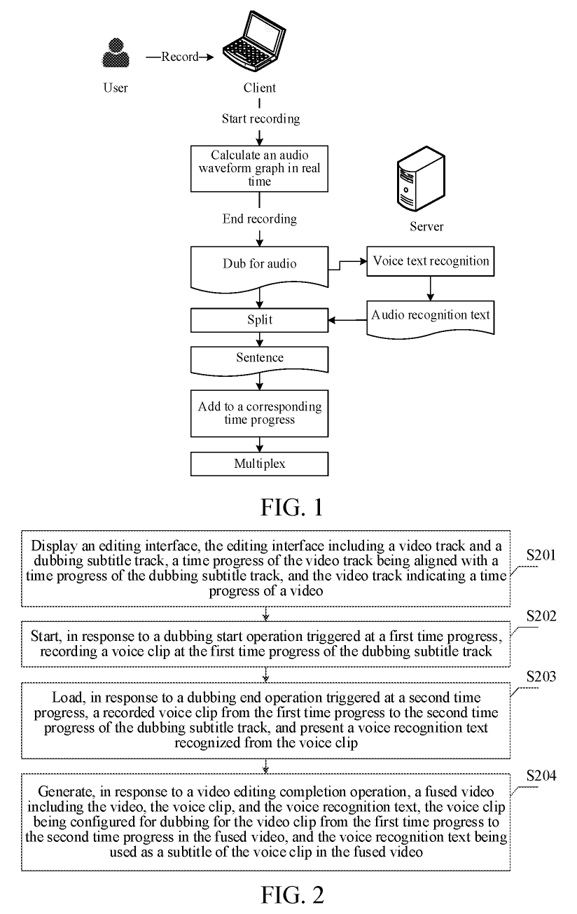

In at least one embodiment, a video editing method based on a natural language processing technology that involves artificial intelligence is provided. According to some embodiments, a procedure of the video editing method may be as follows with reference to FIG. 2.

S201: Display an editing interface, the editing interface including visualized representations of a video track and a dubbing subtitle track, a time progress of the video track being aligned with a time progress of the dubbing subtitle track, and the video track indicating a time progress of a video. For example, an editing interface is displayed on a display. The editing interface includes visualized representations of a video track and a dubbing subtitle track, a time progress of the video track is aligned with a time progress of the dubbing subtitle track, and the video track includes a video.

That the time progresses are aligned means that the time progress of the video track is synchronized with the time progress of the dubbing subtitle track, so that the video track and the dubbing subtitle track are uniformly edited for the same time progress. The editing interface may include a plurality of regions and controls, and each region or control has a specific function to support a user in performing an editing operation on a multimedia stream. The editing interface may include a multi-track region, and the multi-track region includes visualized representations of the video track and the dubbing subtitle track. In some embodiments, in addition to the multi-track region, the editing interface may further include a preview playback region, a resource library region, a special effect panel, and the like.

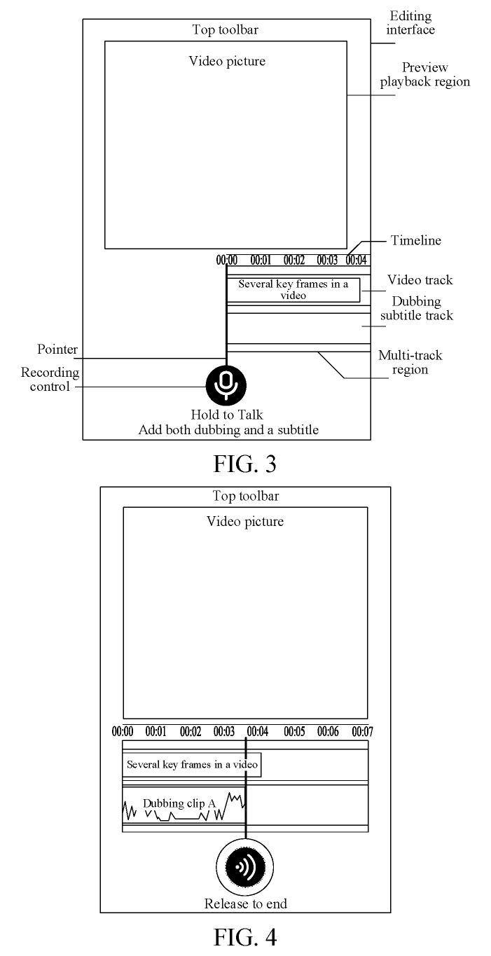

In some embodiments, as shown in FIG. 3, the editing interface may further include a timeline and a pointer. The timeline is a horizontal line, representing a time span of a video, and a scale of the timeline may be a frame or a second. A horizontal direction of the timeline represents flowing of time, and from left to right represents start to end of a video. Each track in the multi-track region is parallel to the timeline, and is configured to accommodate multimedia streams of different types.

A user may position a video picture of a video at a particular time point by dragging the pointer to move on the timeline or directly clicking/tapping a position on the timeline.

The first time point is a start position, on the timeline, at which recording dubbing starts, and corresponds to a particular time point of the video. The first time point may have a preset value, or may be adjusted by the user.

In some embodiments, a position to which the pointer points on the timeline is the first time point. In some embodiments, the user may control the pointer to move on the timeline, for example, drag the pointer to move on the timeline, or control, by using a shortcut key, the pointer to move on the timeline.

In some embodiments, the first time point may be preset as a position corresponding to a first frame of the video on the timeline.

In some embodiments, the first time point may be preset to 00:00 on the timeline.

In some embodiments, the preview playback region may be usable to preview video content that is being edited. The preview playback region may include a playback control bar. The playback control bar may include playback control elements such as play, pause, fast-forward, and fast-rewind. The user may control playback of a video in the preview playback region by using these control elements. The multi-track region may be usable to clip and/or divide a multimedia stream, adjusting an order of the multimedia stream, and adding elements such as audio and a subtitle. The multi-track region may include visualized representations of a video track, an audio track, a subtitle track, a dubbing subtitle track, a special effect track, and the like. The resource library region may present multimedia files in a resource library, for example, a video, audio, an image, and a text. The user may drag a multimedia file from the resource library region to the multi-track region for editing. The special effect panel may present control elements of a plurality of video special effects, and the user may select and apply a video special effect to the multimedia stream in the multi-track region. The pointer may indicate the video time progress of the video or an editing position of the video. Movement of a playback indicator on the timeline indicates a current video playback or editing position.

In some embodiments, the first time point is the position to which the pointer points on the timeline, and the displaying an editing interface further includes: updating the first time point in response to a movement operation on the pointer on the timeline. For example, the first time point may be updated based on a movement operation of the pointer on the timeline.

The movement operation on the pointer on the timeline may include one or more of dragging the pointer to move on the timeline, long pressing a space key to control the pointer to move backward on the timeline, short pressing a restore control to control the pointer to fall back to an initial position on the timeline, or the like.

In some embodiments, the preview playback region may display a video picture of the video at the first time point.

In some embodiments, an initial position of the first time point may be set to a point with value 0 on the timeline. In some embodiments, an initial position of the first time point may be set at a start position or an end position corresponding to the video on the timeline.

S202: Start, in response to a dubbing start operation triggered at the first time point, recording a voice clip at the first time point of the dubbing subtitle track. For example, recording of a voice clip is started when a dubbing start operation is triggered in association with a first time point of the time progress of the dubbing subtitle track.

The dubbing start operation may be set by a technical person according to an implementation requirement. For example, the dubbing start operation may be triggered in manners such as triggering a recording control element, a physical key, and motion control element, or may be automatically triggered when editing software enters the editing interface.

In some examples, as shown in FIG. 3, the editing interface may include a recording control element "Hold to talk". When the user presses and holds the recording control element, the dubbing start operation is triggered.

In some examples, when the user presses and holds a space key of a keyboard, the dubbing start operation is triggered.

In some examples, when the user shakes a mobile terminal, the dubbing start operation is triggered.

In some examples as shown in FIG. 3, when the user presses and holds the recording control element, the dubbing start operation is triggered. In this case, the first time point is 00:00 on the timeline. Therefore, recording of a voice clip starts at 00:00 corresponding to the dubbing subtitle track.

In some embodiments, as shown in FIG. 4, during recording, a waveform graph of recorded audio may be displayed in real time in the visualized representation of the dubbing subtitle track.

In some embodiments, to enable the option of discarding this recording, after the recording of the voice clip starts at the first time point of the dubbing subtitle tracks, a recording cancel control element may be further presented on the editing interface, and the recording of the voice clip may be stopped in response to a recording cancel operation on the recording cancel control element, and the currently recorded voice clip is deleted.

S203: Load, in response to a dubbing end operation triggered at a second time point, a recorded voice clip from the first time point to the second time point of the dubbing subtitle track, and present a voice recognition text recognized from voice clip. For example, the recording of the voice clip is stopped, by the processing circuitry, when a dubbing end operation is triggered in association with a second time point of the time progress of the dubbing subtitle track. In some examples, the recorded voice clip is loaded, by the processing circuitry, into the dubbing subtitle track from the first time point to the second time point of the time progress of the dubbing subtitle track. In some examples, a voice recognition text recognized from the voice clip is displayed in the editing interface.

Similar to operation S202, the dubbing end operation may be set by a technical person according to an actual requirement. For example, the dubbing end operation may be triggered in manners such as ending triggering the recording control, the physical key, and the motion control element, or may be automatically triggered when the editing software enters the editing interface.

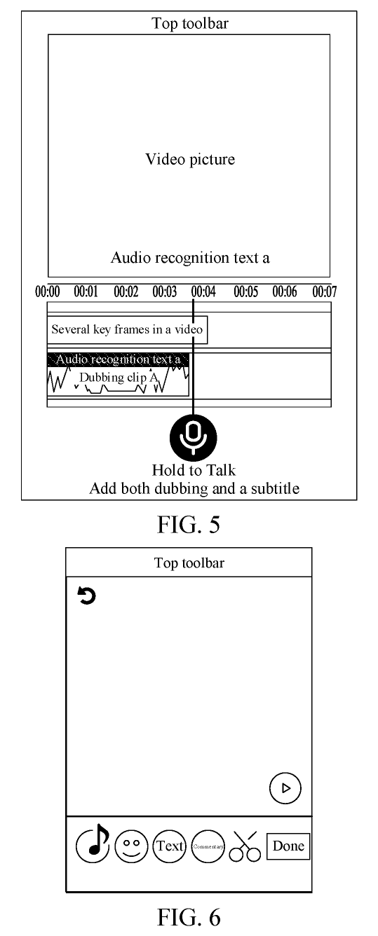

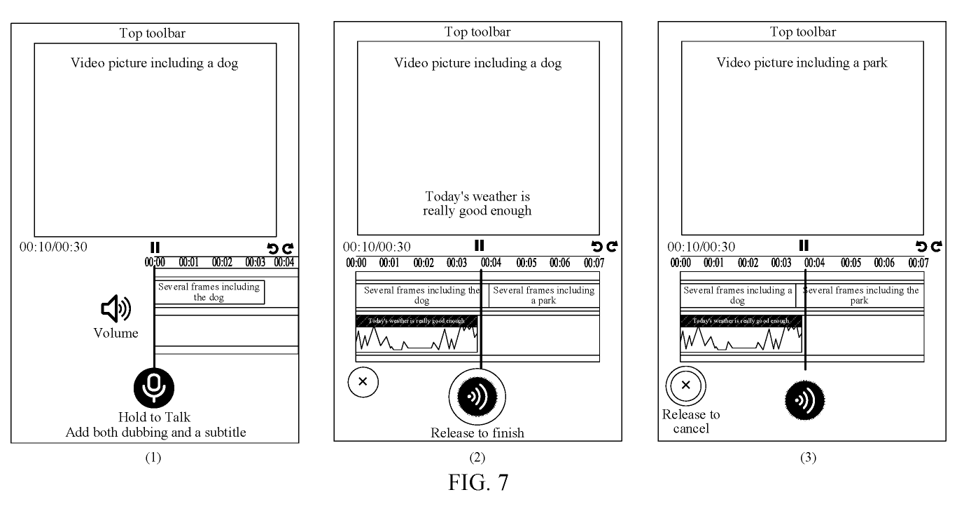

In some examples, as shown in FIG. 5, when the user releases the recording control element, the dubbing end operation is triggered.

In some examples, when the user releases the space key of the keyboard, the dubbing end operation is triggered.

In some examples, when the user stops shaking the mobile terminal, the dubbing end operation is triggered.

As shown in FIG. 5, in some embodiments, when the user releases the recording control element, the dubbing end operation is triggered, a moment at which the dubbing end operation is triggered on the timeline is determined as the second time point, and the voice clip and the voice recognition text recognized from the voice clip are generated. In addition to presenting a waveform graph of the voice clip in the dubbing subtitle track, the voice recognition text of the voice clip may be further presented in or alongside the waveform graph. In other words, a dubbing-subtitle file is generated in conjunction with the dubbing subtitle track. In some examples, the dubbing-subtitle file includes the voice clip and the voice recognition text corresponding to the voice clip.

In some embodiments, dubbing recording may be paused in the halfway, and recording is continued at the pause. In other words, a complete voice clip may be divided into a plurality of dubbing sub-clips, and the plurality of dubbing sub-clips are recorded sequentially.

In some embodiments, to further improve real-time performance of subtitle text presentation, each time recording is paused, a voice recognition text of a currently recorded dubbing sub-clip may be presented in the dubbing subtitle track. Therefore, after operation S202 and before operation S203, the method further includes:

generating, in response to a dubbing pause operation, a dubbing sub-clip and a voice recognition subtext corresponding to the dubbing sub-clip, the dubbing pause operation corresponding to a pause time point, the dubbing sub-clip being loaded from the first time point to the pause time point of the dubbing subtitle track, and the voice recognition subtext being presented at the voice clip; and

starting, in response to a dubbing continue operation, recording the voice clip at the first time point of the dubbing subtitle track.

For example, a text "It is sunny today. I walk a dog in the park..." is set. A user starts dubbing at 00:00 on the timeline, that is, 00:00 is the first time point. The user finishes "It is sunny today" at 00:12 on the timeline and immediately pauses dubbing, that is, 00:12 is the pause time point. In this case, a currently recorded dubbing sub-clip is generated in the dubbing subtitle track corresponding to 00:00 to 00:12 on the timeline, and a voice recognition sub-text "It is sunny today" is presented in the dubbing sub-clip. The user may continue recording the remaining text at 00:12.

In some embodiments, after operation S203, the method further includes: deleting, in response to a deletion operation on the voice recognition text in the dubbing subtitle track, the voice clip in the dubbing subtitle track at the same time.

For example, if either the voice clip or the voice recognition text in the dubbing-subtitle file is deleted, both the voice clip and voice recognition text are directly deleted.

In some embodiments, after operation S203, the method further includes: updating the voice recognition text in response to a text modification operation on the voice recognition text.

In some embodiments, the text modification operation includes one or more of a content modification operation, a style modification operation, a position modification operation, or an animation special effect editing operation. For example, the content modification operation may include modifying text content. The style modification operation may include modifying a font style such as a font, bold, underline, italic, background color, or highlight of a text. The position modification operation may include modifying a presentation position of text content in a video picture. The animation special effect editing operation may include adding or deleting an animation effect such as slow in and slow out, bounce, rotation, or flicker for the text.

The text modification operation on the voice recognition text may be implemented by using a shortcut key, a modification control element, or the like. For example, text modification may be performed on the voice recognition text by double-clicking/tapping the voice recognition text in the dubbing subtitle track.

In some embodiments, after operation S203, the method further includes: determining a target special effect in response to a special effect addition operation on the voice clip in the dubbing subtitle track; performing voice change processing on the voice clip by using the target special effect, to obtain a voice-changed voice clip; and replacing the voice clip in the dubbing subtitle track with the voice-changed voice clip.

An audio special effect may include one or more of reverberation, echo, vibrato, surround sound, or the like.

In some embodiments, voice change processing may be performed on the voice clip through a server by using the target special effect, to obtain the voice-changed voice clip. For example, a client sends the voice clip and a special effect number of the target special effect to the server, and the server performs voice change processing on the voice clip based on an algorithm using the target special effect, to obtain the voice-changed voice clip, and finally returns the voice-changed voice clip.

In some embodiments, to facilitate pre-listening a special effect by the user, the replacing the voice clip in the dubbing subtitle track with the voice-changed voice clip includes: playing the voice-changed voice clip for audition; and replacing, in response to an addition confirmation operation, the voice clip in the dubbing subtitle track with the voice-changed voice clip.

In some embodiments, to facilitate fine-tuning, by the user, a time point at which a dubbing occurs in the video, after operation S203, the method further includes: updating, in response to a movement operation on the voice clip in the dubbing subtitle track, the first time point and the second time point based on a position of the moved voice clip in the dubbing subtitle track. For example, when a movement operation is performed on the visualized representation of the voice clip in the dubbing subtitle track to move the visualized representation of the voice clip to an updated position with respect to the visualized representation of the dubbing subtitle track, a starting time point and an ending time point of the voice clip in the dubbing subtitle track are updated based on the updated position.

For example, the movement operation may include dragging the voice clip to move in the dubbing subtitle track.

In some embodiments, in contrast to a design of a dubbing-subtitle file solution, the voice clip and the voice recognition text in the dubbing-subtitle file may be separated, to independently adjust the voice clip or the voice recognition text. Therefore, the dubbing subtitle track may be set to include a dubbing sub-track and a subtitle sub-track, the voice clip is loaded from the first time point to the second time point of the dubbing sub-track, and the voice recognition text is loaded from the first time point to the second time point of the subtitle sub-track and at a position in which the voice clip is loaded. The updating, in response to a movement operation on the voice clip in the dubbing subtitle track, the first time point and the second time point based on a position of the moved voice clip in the dubbing subtitle track includes:

updating, in response to the movement operation on the voice clip in the dubbing sub-track, the first time point and the second time point of the voice clip based on a position of the voice clip in the dubbing sub-track; and

updating, in response to the movement operation on the voice recognition text in the subtitle sub-track, a position of the voice recognition text in the dubbing sub-track, and updating the first time point and the second time point of the voice recognition text.

In some examples, the updating the starting time point and the ending time point of the voice clip includes updating, when the movement operation is performed on the visualized representation of the voice clip in the dubbing sub-track, a position of the voice clip in the dubbing sub-track based on a position of the moved visualized representation of the voice clip with respect to the visualized representation of the dubbing sub-track. In some examples, the updating the starting time point and the ending time point of the voice clip includes updating, when a movement operation is performed on a visualized representation of the voice recognition text in the subtitle sub-track, a position of the voice recognition text in the dubbing sub-track based on a position of the moved visualized representation of the voice recognition text with respect to the visualized representation of the subtitle sub-track.

In some embodiments, after operation S203, the method further includes:

deleting, in response to a deletion operation on the voice clip in the dubbing subtitle track, both the voice clip and the voice recognition text in the dubbing subtitle track.

In some embodiments, the editing interface further includes the preview playback region, the video track and the dubbing subtitle track have the same timeline, and the timeline includes a preview time point. After operation S203, the method further includes:

when the preview time point is between the first time point and the second time point, playing, in response to a preview operation, a video picture of the video at the preview time point in the preview playback region, and presenting the voice recognition text on the video picture at the preview time point. For example, the editing interface further includes a preview playback region. A preview time progress of a preview operation in the preview playback region, the time progress of the video track, and the time progress of the dubbing subtitle track are based on a same timeline. In some examples, when the preview time progress of the preview operation is at a preview time point between the first time point and the second time point, a video picture of the video at the preview time point is played in the preview playback region, and the voice recognition text is displayed on the video picture.

For example, a user dubs "Today's weather is really good enough" from t₁ to t₂ of a video, and dubs "I walk a dog in the park" from t₃ to t₄ of the video. Therefore, when the video is played at t₁ to t₂ in the preview playback region, in addition to presenting a video picture, a subtitle "Today's weather is really good enough" is further presented on the video picture. When the video is played at t₃ to t₄ in the preview playback region, in addition to presenting a video picture, a subtitle "I walk a dog in the park" is further presented on the video picture. t₁ to t₄ refer to four different time points in the video.

In some embodiments, the playing a video picture of the video at the preview time point in the preview playback region, and presenting the voice recognition text on the video picture at the preview time point further includes:

playing video audio of the video at the preview time point and the voice clip.

S204: Generate, in response to a video editing completion operation, a fused video including the video, the voice clip, and the voice recognition text, the voice clip being for dubbing for a video segment from the first time point to the second time point in the fused video, and the voice recognition text being usable as a subtitle of the voice clip in the fused video. For example, a fused video including the video, the voice clip, and the voice recognition text is generated by processing circuitry based on a video editing completion operation. In some examples, the voice clip is playable with a video segment from the first time point to the second time point in the fused video. In some examples, the voice recognition text is usable as a subtitle of the voice clip in the fused video.

One or more embodiments of this disclosure provide a multiplexing method in which both a dubbing and a dubbing subtitle are added. A user may record a dubbing at an appropriate video progress by using the editing interface, and the dubbing and a dubbing subtitle may be immediately generated at the video point after recording is completed. In other words, the user can rapidly complete multiplexing of adding both the dubbing and the dubbing subtitle by performing only three operations: starting dubbing, ending dubbing, and multiplexing.

In this disclosure, one or more of the following operations may be omitted, including: 1: Prepare a dubbing file in advance; 2: Import the dubbing into editing software; 3: Adjust positions at which the dubbing appears and the dubbing ends in a video progress; 4: Prepare a dubbing subtitle file corresponding to the dubbing in advance; 5: Import the dubbing subtitle into the editing software; 6: Adjust positions at which the dubbing subtitle appears and the dubbing subtitle ends in the video progress; or 7: Repeat operation 1 to operation 6 for a plurality of times, to add a plurality of pre-prepared dubbing and dubbing subtitles. Therefore, one or more embodiments of this disclosure provide a more rapid and concise multiplexing method, to reduce operation complexity of a current video multiplexing method.

In some embodiments, in addition to the multiplexing method that is for multiplexing dubbing and a subtitle corresponding to the dubbing through recording of the dubbing and that is provided in operation S201 to operation 204, a multiplexing method for multiplexing both a subtitle and dubbing corresponding to the subtitle through dubbing of the subtitle is further provided. The multiplexing method includes: adding a target subtitle to the dubbing subtitle track in response to a subtitle addition operation, the target subtitle being located between a third time point and a fourth time point of the dubbing subtitle track; and generating a voice recitation clip corresponding to the target subtitle between the third time point and the fourth time point of the dubbing subtitle track.

The generating, in response to a video editing completion operation, a fused video including the video, the voice clip, and the voice recognition text includes: generating, in response to the video editing completion operation, the fused video including the video, the voice clip, the voice recognition text, the target subtitle, and the voice recitation clip, the voice recitation clip being for dubbing for a video segment from the third time point to the fourth time point in the fused video, and the target subtitle being usable as a subtitle of the voice recitation clip in the fused video.

For example, a subtitle is converted into dubbing through AI dubbing, that is, the voice recitation clip.

For example, in this embodiment of this disclosure, the editing interface may be displayed, the editing interface including the multi-track region, the multi-track region including the video track and the dubbing subtitle track, the time progress of the video track being aligned with the time progress of the dubbing subtitle track, and the video track indicating the time progress of the video; recording of the voice clip is started at the first time progress of the dubbing subtitle track in response to the dubbing start operation triggered at the first time point; the voice clip and the voice recognition text recognized from the voice clip are generated in response to the dubbing end operation triggered at the second time point, the dubbing end operation carrying the second time point, the voice clip being loaded from the first time point to the second time point of the dubbing subtitle track, and the voice recognition text being presented at the voice clip; and the fused video including the video, the voice clip, and the voice recognition text is generated in response to the video editing completion operation, the voice clip being for dubbing for the video segment from the first time progress to the second time progress in the fused video, and the voice recognition text being usable as the subtitle of the voice clip in the fused video. Therefore, in the solution according to one or more embodiments of this disclosure, through recording of dubbing, both the dubbing and a subtitle corresponding to the dubbing are multiplexed. The user can rapidly multiplex both the dubbing and the subtitle of the dubbing only by performing the three operations of starting dubbing, ending dubbing, and multiplexing, to reduce operation complexity of the video editing method.

According to the method described in the foregoing embodiments, the following further describes the method in detail.

In this embodiment, the method in this embodiment of this disclosure is described in detail by using an example of video editing software on an intelligent terminal and communication with a cloud server.

In this embodiment, the user records voice and can directly see a subtitle matching voice content in the dubbing subtitle track when recording ends.

In FIG. 6, after opening a video by using a video editor, the user clicks/taps a "commentary" control element on a home page of the video editor to enter an editing interface.

In example (1) in FIG. 7, the editing interface includes a video track, a dubbing subtitle track, a preview playback region, a timeline, a pointer, a recording control element "Hold to talk", and the like. The video may be automatically imported into the video track, or another video may be manually imported by the user. In example (2) in FIG. 7, when the user long presses the recording control element "Hold to talk", dubbing may be recorded in the dubbing subtitle track in real time, and a waveform graph of the dubbing is displayed in real time. When the user releases the recording control element "Hold to talk", a recorded voice clip and a subtitle text "Today's weather is really good enough" corresponding to the recorded voice clip are presented in the dubbing subtitle track. Referring to (3) in FIG. 7, the user may continue to record a next clip of dubbing. During recording each time, a recording cancel control element "Release to cancel" may be presented in the editing interface. When the user long presses the recording control element "Hold to talk" and drags the recording control element to the recording cancel control element "Release to cancel", recording of a voice clip may be stopped, and currently recorded audio data is deleted.

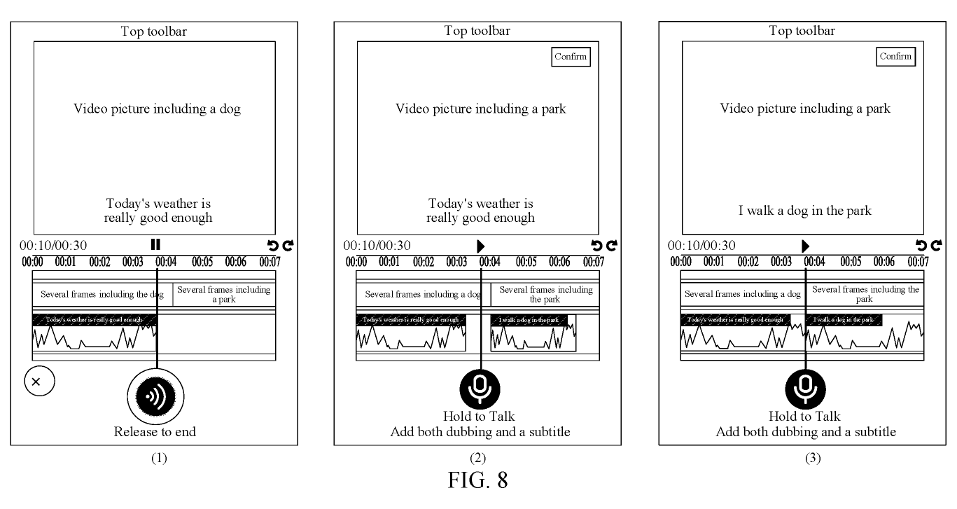

In FIG. 8, each time recording is completed, a client may send currently recorded dubbing to a server. The server converts the dubbing into a corresponding subtitle and returns the corresponding subtitle to the client. The client presents the subtitle in a waveform graph of the dubbing corresponding to the dubbing.

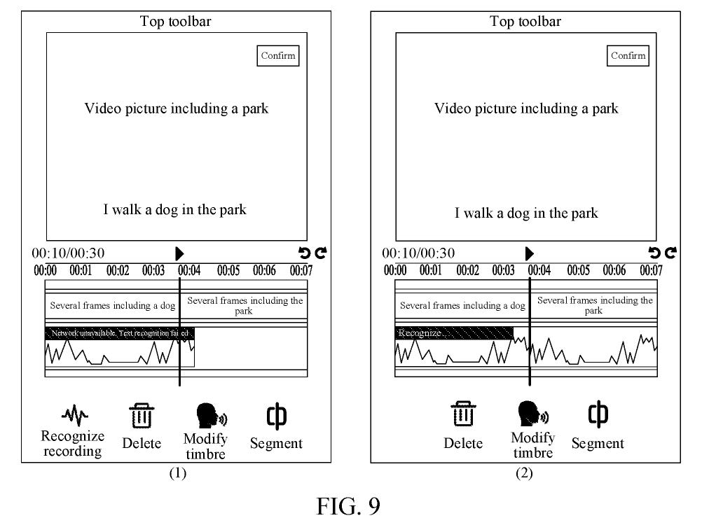

In example (1) in FIG. 9, when communication with the server cannot be performed, a communication failure prompt "Network unavailable. Text recognition failed" may be presented on the waveform graph of the currently recorded dubbing. In example (2) in FIG. 9, when the client waits for the server to return the subtitle, a communication failure prompt "Recognizing…" may be presented on the waveform graph of the currently recorded dubbing.

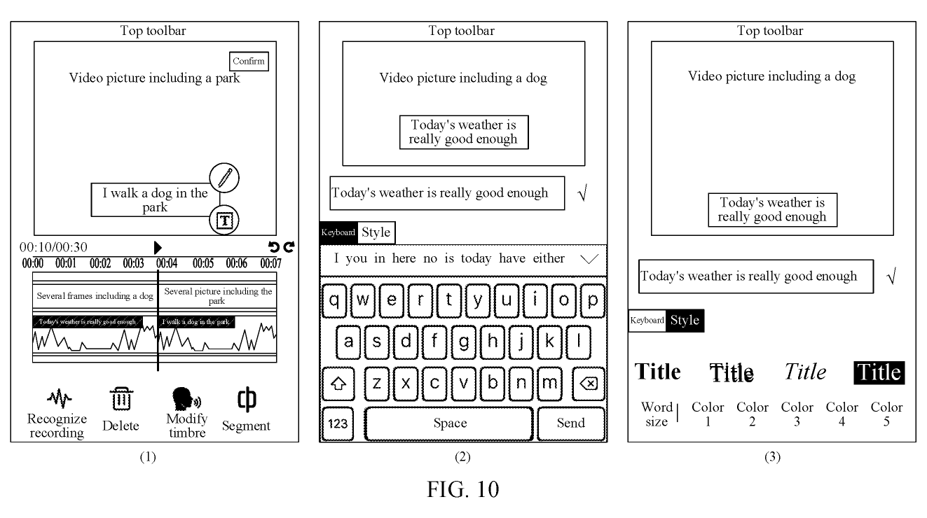

In example (1) in FIG. 10, the user may perform clicking/tapping to select a subtitle presented in the preview playback region, to perform a text modification operation on the subtitle, for example, implement a position modification operation by dragging the subtitle, that is, modify a position of the subtitle in a video picture. For example, the subtitle is deleted, for example, in example (2) in FIG. 10, a content modification operation is performed on the subtitle. For example, in example (3) in FIG. 10, a style modification operation is performed on the subtitle.

Referring to FIG. 11, the user may determine a target special effect in response to a special effect addition operation on a voice clip in the dubbing subtitle track in the client; and the client sends the voice clip and a special effect number of the target special effect to the server, so that the server performs voice changing processing on the voice clip by using the target special effect, to obtain a voice-changed voice clip, and returns the voice-changed voice clip to the client. The client replaces the voice clip in the dubbing subtitle track with the voice-changed voice clip.

In some embodiments, as shown in FIG. 11, the editing interface may further include an all-application control element "Apply to all". After selecting the target special effect, the user clicks/taps the all-application control element "Apply to all", and may apply, by using one click/tap, the target special effect to all dubbing in the dubbing subtitle track.

In this embodiment of this disclosure, the operation complexity of the video editing method can be reduced.

To better implement the foregoing method, an embodiment of this disclosure further provides a video editing apparatus. The video editing apparatus may be integrated into an electronic device, and the electronic device may be a device such as a terminal or a server. The terminal may be a device such as a mobile phone, a tablet computer, a smart Bluetooth device, a notebook computer, or a personal computer. The server may be a single server, or may be a server cluster including a plurality of servers.

In some embodiments, the method in this disclosure is described in detail by using an example in which the video editing apparatus is integrated into a smartphone.

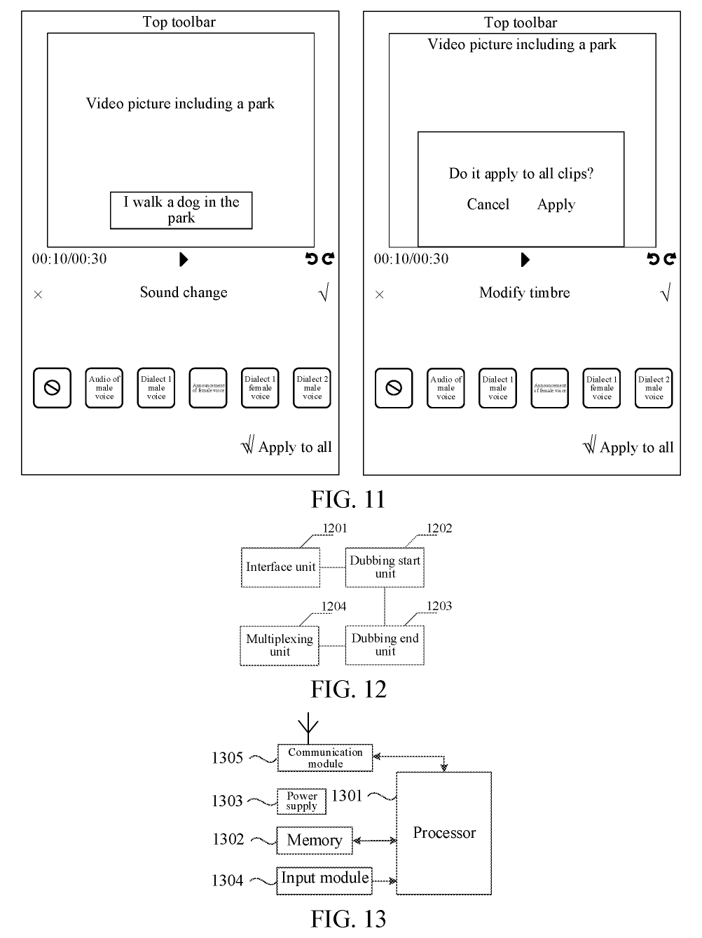

For example, as shown in FIG. 12, the video editing apparatus may include an interface unit 1201, a dubbing start unit 1202, a dubbing end unit 1203, and a multiplexing unit 1204.

(1) Interface unit 1201

The interface unit 1201 is configured to display an editing interface, the editing interface including a multi-track region, the multi-track region including a video track and a dubbing subtitle track, a time progress of the video track being aligned with a time progress of the dubbing subtitle track, and the video track indicating a time progress of a video.

In some embodiments, the editing interface further includes a pointer, and the first time point is a position to which the pointer points on the timeline. The displaying an editing interface further includes:

updating the first time point in response to a movement operation on the pointer on the timeline.

(2) Dubbing start unit 1202

The dubbing start unit 1202 is configured to start, in response to a dubbing start operation triggered at a first time point, recording a voice clip at the first time point of the dubbing subtitle track.

(3) Dubbing end unit 1203

The dubbing end unit 1203 is configured to load, in response to a dubbing end operation triggered at a second time point, a recorded voice clip from the first time point to the second time point of the dubbing subtitle track, and present a voice recognition text recognized from the voice clip.

In in some embodiments, after the loading, in response to a dubbing end operation triggered at a second time point, a recorded voice clip from the first time point to the second time point of the dubbing subtitle track, and presenting a voice recognition text recognized from the voice clip, the method further includes:

updating the voice recognition text in response to a text modification operation on the voice recognition text.

In some embodiments, the text modification operation includes a content modification operation, a style modification operation, a position modification operation, and an animation special effect editing operation.

In in some embodiments, after the loading, in response to a dubbing end operation triggered at a second time point, a recorded voice clip from the first time point to the second time point of the dubbing subtitle track, and presenting a voice recognition text recognized from the voice clip, the method further includes:

determining a target special effect in response to a special effect addition operation on the voice clip in the dubbing subtitle track;

performing voice change processing on the voice clip by using the target special effect, to obtain a voice-changed voice clip; and

replacing the voice clip in the dubbing subtitle track with the voice-changed voice clip.

In some embodiments, the replacing the voice clip in the dubbing subtitle track with the voice-changed voice clip includes:

performing playback on the voice-changed voice clip for audition; and

replacing, in response to an addition confirmation operation, the voice clip in the dubbing subtitle track with the voice-changed voice clip.

In some embodiments, after the loading, in response to a dubbing end operation triggered at a second time point, a recorded voice clip from the first time point to the second time point of the dubbing subtitle track, and presenting a voice recognition text recognized from the voice clip, the method further includes:

updating, in response to a movement operation on the voice clip in the dubbing subtitle track, the first time point and the second time point based on a position of the moved voice clip in the dubbing subtitle track.

In some embodiments, the dubbing subtitle track includes a dubbing sub-track and a subtitle sub-track, the voice clip is loaded from the first time point to the second time point of the dubbing sub-track, and the voice recognition text is loaded from the first time point to the second time point of the subtitle sub-track and at a position in which the voice clip is loaded. The updating, in response to a movement operation on the voice clip in the dubbing subtitle track, the first time point and the second time point based on a position of the moved voice clip in the dubbing subtitle track includes:

updating, in response to a movement operation on the voice clip in the dubbing sub-track, the first time point and the second time point of the voice clip based on a position of the voice clip in the dubbing sub-track; and

updating, in response to a movement operation on the voice recognition text in the subtitle sub-track, a position of the voice recognition text in the dubbing sub-track, and updating the first time point and the second time point of the voice recognition text.

In some embodiments, after the loading, in response to a dubbing end operation triggered at a second time point, a recorded voice clip from the first time point to the second time point of the dubbing subtitle track, and presenting a voice recognition text recognized from the voice clip, the method further includes:

deleting, in response to a deletion operation on the voice clip in the dubbing subtitle track, both the voice clip and the voice recognition text from the dubbing subtitle track.

In some embodiments, the editing interface further includes a preview playback region, the video track and the dubbing subtitle track have a same timeline, the timeline includes a preview time point. After the loading, in response to a dubbing end operation triggered at a second time point, a recorded voice clip from the first time point to the second time point of the dubbing subtitle track, and presenting a voice recognition text recognized from the voice clip, the method further includes:

when the preview time point is between the first time point and the second time point, playing, in response to a preview operation, a video picture of the video at the preview time point in the preview playback region, and presenting the voice recognition text on the video picture at the preview time point.

In some embodiments, the playing a video picture of the video at the preview time point in the preview playback region, and presenting the voice recognition text on the video picture at the preview time point further includes:

playing video audio of the video at the preview time point and the voice clip.

(4) Multiplexing unit 1204

The multiplexing unit 1204 is configured to generate, in response to a video editing completion operation, a fused video including the video, the voice clip, and the voice recognition text, the voice clip being configured for dubbing for a video segment from the first time point to the second time point in the fused video, and the voice recognition text being usable as a subtitle of the voice clip in the fused video.

In some embodiments, the video editing method further includes:

adding a target subtitle to the dubbing subtitle track in response to a subtitle addition operation, the target subtitle being located between a third time point and a fourth time point of the dubbing subtitle track; and

generating a voice recitation clip corresponding to the target subtitle between the third time point and the fourth time point of the dubbing subtitle track; and

the generating, in response to a video editing completion operation, a fused video including the video, the voice clip, and the voice recognition text includes:

generating, in response to the video editing completion operation, the fused video including the video, the voice clip, the voice recognition text, the target subtitle, and the voice recitation clip, the voice recitation clip being configured for dubbing for a video segment from the third time point to the fourth time point in the fused video, and the target subtitle being usable as a subtitle of the voice recitation clip in the fused video.

During specific implementation, the foregoing units may be implemented as independent entities, or may be combined arbitrarily, or may be implemented as a same entity or several entities. For specific implementation of the foregoing units, refer to the foregoing method embodiments. Details are not described herein again.

In the embodiments of this disclosure, term "module" or "unit" refers to a computer program with a predetermined function or a part of the computer program, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In the video editing apparatus of this embodiment, the interface unit displays the editing interface, the editing interface including the multi-track region, the multi-track region including the video track the dubbing subtitle track, the time progress of the video track being aligned with the time progress of the dubbing subtitle track, and the video track indicating the time progress of the video; the dubbing start unit starts, in response to the dubbing start operation triggered at the first time point, recording of the voice clip at the first time point of the dubbing subtitle track; the dubbing end unit loads, in response to the dubbing end operation triggered at the second time point, the recorded voice clip from the first time point to the second time point of the dubbing subtitle track, and presents the voice recognition text recognized from the voice clip; the multiplexing unit generates, in response to the video editing completion operation, the fused video including the video, the voice clip, and a voice recognition text, the voice clip being configured for dubbing for the video segment from the first time point to the second time point in the fused video, and the voice recognition text being used as the subtitle of the voice clip in the fused video.

Therefore, in this embodiment of this disclosure, operation complexity of the video editing method can be reduced.

An embodiment of this disclosure further provides an electronic device. The electronic device may be a device such as a terminal or a server. The terminal may be a device such as a mobile phone, a tablet computer, a smart Bluetooth device, a notebook computer, or a personal computer. The server may be a single server, or may be a server cluster including a plurality of servers.

In some embodiments, the video editing apparatus may be integrated into a plurality of electronic devices. For example, the video editing apparatus may be integrated into a plurality of servers, and the plurality of servers implements the video editing method of this disclosure.

In this embodiment, an example in which the electronic device in this embodiment is a smartphone as a non-limiting example. For example, as shown in FIG. 13, FIG. 13 is a schematic diagram of a structure of an electronic device according to an embodiment of this disclosure.

The electronic device may include components such as processing circuitry (e.g., a processor 1301) including one or more processing cores, a memory 1302 including one or more computer-readable storage media (e.g., including a non-transitory computer-readable storage medium), a power supply 1303, an input module 1304, and a communication module 1305. A person skilled in the art may understand that a structure of the electronic device shown in FIG. 13 does not constitute a limitation to the electronic device, and the electronic device may include more components or fewer components than those shown in the figure, or some components may be combined, or a different component deployment may be used.

The processor 1301 is a control center of the electronic device, and is connected to various parts of the entire electronic device by using various interfaces and lines. By running or executing a software program and/or module stored in the memory 1302 (e.g., stored in the non-transitory computer-readable storage medium), and invoking data stored in the memory 1302, the processor 1301 performs various functions of the electronic device and processes data, thereby performing overall detection on the electronic device. In some embodiments, the processor 1301 may include one or more processing cores. In some embodiments, the processor 1301 may integrate an application processor and a modem processor. The application processor mainly processes an operating system, a user interface, an application program, and the like. The modem processor mainly processes wireless communication. The modem processor may not be integrated into the processor 1301.

The memory 1302 may be configured to store a software program and module. The processor 1301 runs the software program and module stored in the memory 1302, to implement various functional applications and data processing. The memory 1302 may mainly include a program storage region and a data storage region. The program storage region may correspond to a non-transitory computer-readable storage medium and may store the operating system, an application program required by at least one function (such as a sound playback function and an image display function), and the like. The data storage region may store data created according to use of the electronic device, and the like. In addition, the memory 1302 may include a high speed random access memory, and may also include a non-volatile memory such as at least one magnetic disk storage device, a flash memory, or another volatile solid-state storage device. Correspondingly, the memory 1302 may further include a memory controller, so as to provide access of the processor 1301 to the memory 1302.

The electronic device further includes the power supply 1303 for supplying power to the components. In some embodiments, the power supply 1303 may be logically connected to the processor 1301 through a power management system, thereby implementing functions such as charging, discharging, and power consumption management by using the power management system. The power supply 1303 may further include one or more of a direct current or alternating current power supply, a re-charging system, a power failure detection circuit, a power supply converter or inverter, a power supply state indicator, and any other components.

The electronic device may further include the input module 1304. The input module 1304 may be configured to receive inputted digit or character information, and generate a keyboard, mouse, joystick, optical, or track ball signal input related to the user setting and function control.

The electronic device may further include the communication module 1305. In some embodiments, the communication module 1305 may include a wireless module. The electronic device may perform short-distance wireless transmission by using the wireless module of the communication module 1305, so as to provide wireless broadband Internet access for the user. For example, the communication module 1305 may be configured to help a user receive and send e-mails, browse a web page, access streaming media, and the like.

Although not shown in the figure, the electronic device may further include a display unit and the like. Details are not described herein. Specifically, in this embodiment, the processor 1301 of the electronic device may load, according to the following instructions, executable files corresponding to processes of one or more application programs into the memory 1302, and the processor 1301 runs the application programs stored in the memory 1302, to implement various functions as follows:

displaying an editing interface, the editing interface including a multi-track region, the multi-track region including a video track and a dubbing subtitle track, a time progress of the video track being aligned with a time progress of the dubbing subtitle track, and the video track indicating a time progress of a video;

starting, in response to a dubbing start operation triggered at a first time point, recording a voice clip at the first time point of the dubbing subtitle track;

loading, in response to a dubbing end operation triggered at a second time point, a recorded voice clip from the first time point to the second time point of the dubbing subtitle track, and presenting a voice recognition text recognized from the voice clip; and

generating, in response to a video editing completion operation, a fused video including the video, the voice clip, and the voice recognition text, the voice clip being configured for dubbing for a video segment from the first time point to the second time point in the fused video, and the voice recognition text being usable as a subtitle of the voice clip in the fused video.

For implementation details of the foregoing operations, refer to the foregoing embodiments. Details are not described herein again.

In this embodiment of this disclosure, the operation complexity of the video editing method can be reduced.

A person of ordinary skill in the art may understand that all or some of the operations of various methods in the foregoing embodiments may be implemented through instructions, or implemented through instructions controlling relevant hardware. The instructions may be stored in a computer-readable storage medium, and loaded and executed by the processor.

Therefore, an embodiment of this disclosure provides a non-transitory computer-readable storage medium, having a plurality of instructions stored therein. The instructions are can be loaded by processing circuitry (e.g., a processor), to perform the operations of the video editing method according to the embodiment of this disclosure. For example, the instructions may perform the following operations:

displaying an editing interface, the editing interface including a multi-track region, the multi-track region including a video track and a dubbing subtitle track, a time progress of the video track being aligned with a time progress of the dubbing subtitle track, and the video track indicating a time progress of a video;

starting, in response to a dubbing start operation triggered at a first time point, recording a voice clip at the first time point of the dubbing subtitle track;

loading, in response to a dubbing end operation triggered at a second time point, a recorded voice clip from the first time point to the second time point of the dubbing subtitle track, and presenting a voice recognition text recognized from the voice clip; and

generating, in response to a video editing completion operation, a fused video including the video, the voice clip, and the voice recognition text, the voice clip being configured for dubbing for a video segment from the first time point to the second time point in the fused video, and the voice recognition text being usable as a subtitle of the voice clip in the fused video.

The storage medium may include: a read only memory (ROM), a random access memory (RAM), a magnetic disk, an optical disc, or the like.

According to an aspect of this disclosure, a computer program product or a computer program is provided. The computer program product or the computer program includes computer instructions, and the computer instructions are stored in a non-transitory computer-readable storage medium Processing circuitry (e.g., a processor) of a computer device reads the computer instructions from the non-transitory computer-readable storage medium, and executes the computer instructions, so that the computer device performs the methods provided in the various implementations in the video multiplexing aspect or the multimedia editing aspect provided in the foregoing embodiments.

Because the instructions stored in the non-transitory computer-readable storage medium may be usable to implement the operations of any video editing method in the embodiments of this disclosure, the instructions can achieve beneficial effects that may be achieved by any video editing method in the embodiments of this disclosure. For details, refer to the foregoing embodiments. Details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Technical features of the foregoing embodiments may be combined in various manners. For the purpose of concise descriptions, not all possible combinations of the technical features in the foregoing embodiments are described, but as long as combinations of the technical features do not conflict each other, the combinations of the technical features are to be considered as falling within the scope of this disclosure.

The foregoing embodiments only describe several implementations of this disclosure, and their descriptions are specific and detailed, but cannot therefore be understood as a limitation to the scope of the present disclosure. Some variations and modifications may be made by a person of ordinary skill in the art without departing from the spirit of this disclosure, and all of the variations and modifications fall within the scope of this disclosure.

What is claimed is:

1. A video editing method, comprising:
displaying, on a display, an editing interface, the editing interface including visualized representations of a video track and a dubbing subtitle track, a time progress of the video track being aligned with a time progress of the dubbing subtitle track, and the video track including a video;
starting, by processing circuitry, recording of a voice clip when a dubbing start operation is triggered in association with a first time point of the time progress of the dubbing subtitle track;
stopping, by the processing circuitry, the recording of the voice clip when a dubbing end operation is triggered in association with a second time point of the time progress of the dubbing subtitle track;
loading, by the processing circuitry, the recorded voice clip into the dubbing subtitle track from the first time point to the second time point of the time progress of the dubbing subtitle track;
displaying in the editing interface a voice recognition text recognized from the voice clip; and
generating, by the processing circuitry based on a video editing completion operation, a fused video including the video, the voice clip, and the voice recognition text, wherein
the voice clip is playable with a video segment from the first time point to the second time point in the fused video, and
a subtitle of the voice clip in the fused video includes the voice recognition text.

2. The video editing method according to claim 1, further comprising:
updating the voice recognition text based on a text modification operation on the voice recognition text.

3. The video editing method according to claim 2, wherein the text modification operation comprises one or more of a content modification operation, a style modification operation, a position modification operation, or an animation special effect editing operation.

4. The video editing method according to claim 1, further comprising:
determining a target special effect when a special effect addition operation is performed on the visualized representation of the voice clip in the dubbing subtitle track;
performing voice change processing on the voice clip by using the target special effect, to obtain a voice-changed voice clip; and
replacing the voice clip in the dubbing subtitle track with the voice-changed voice clip.

5. The video editing method according to claim 4, wherein the replacing the voice clip in the fused video with the voice-changed voice clip comprises:
playing the voice-changed voice clip; and
replacing, based on an addition confirmation operation, the voice clip in the dubbing subtitle track with the voice-changed voice clip.

6. The video editing method according to claim 1, further comprising:
updating, when a movement operation is performed on the visualized representation of the voice clip in the dubbing subtitle track to move the visualized representation of the voice clip to an updated position with respect to the visualized representation of the dubbing subtitle track, a starting time point and an ending time point of the voice clip in the dubbing subtitle track based on the updated position.

7. The video editing method according to claim 6, wherein
the dubbing subtitle track includes a dubbing sub-track and a subtitle sub-track,
the voice clip is included in the dubbing sub-track from the first time point to the second time point,
the voice recognition text is included in the subtitle sub-track from the first time point to the second time point, and
the updating the starting time point and the ending time point of the voice clip includes:
updating, when the movement operation is performed on the visualized representation of the voice clip in the dubbing sub-track, a position of the voice clip in the dubbing sub-track based on a position of the moved visualized representation of the voice clip with respect to the visualized representation of the dubbing sub-track; and
updating, when a movement operation is performed on a visualized representation of the voice recognition text in the subtitle sub-track, a position of the voice recognition text in the dubbing sub-track based on a position of the moved visualized representation of the voice recognition text with respect to the visualized representation of the subtitle sub-track.

8. The video editing method according to claim 1, wherein the method further comprises:
deleting, based on a deletion operation on the voice clip in the dubbing subtitle track, both the voice clip and the voice recognition text from the dubbing subtitle track.

9. The video editing method according to claim 1, wherein
the editing interface further includes a preview playback region, a preview time progress of a preview operation in the preview playback region, the time progress of the video track, and the time progress of the dubbing subtitle track being based on a same timeline, and
the method further includes, when the preview time progress of the preview operation is at a preview time point between the first time point and the second time point:
playing a video picture of the video at the preview time point in the preview playback region; and
displaying the voice recognition text on the video picture.

10. The video editing method according to claim 9, further comprising:
playing video audio of the video and the voice clip based on the preview time progress.

11. The video editing method according to claim 1, wherein
the editing interface further includes a timeline and a pointer, the first time point corresponding to a position to which the pointer points on the timeline, and
the displaying an editing interface includes updating the first time point based on a movement operation of the pointer on the timeline.

12. The video editing method according to claim 1, further comprising:
adding a target subtitle to the dubbing subtitle track based on a subtitle addition operation, the target subtitle being between a third time point and a fourth time point of the time progress of the dubbing subtitle track; and
generating a voice recitation clip corresponding to the target subtitle between the third time point and the fourth time point, wherein
the fused video further includes the target subtitle and the voice recitation clip,
the voice recitation clip is playable with another video segment from the third time point to the fourth time point in the fused video, and
the target subtitle is displayable as a subtitle of the voice recitation clip in the fused video.

13. A video editing apparatus, comprising:
processing circuitry configured to:
display, on a display, an editing interface, the editing interface including visualized representations of a video track and a dubbing subtitle track, a time progress of the video track being aligned with a time progress of the dubbing subtitle track, and the video track including a video;
start recording of a voice clip when a dubbing start operation is triggered in association with a first time point of the time progress of the dubbing subtitle track;
stop the recording of the voice clip when a dubbing end operation is triggered in association with a second time point of the time progress of the dubbing subtitle track;
load the recorded voice clip into the dubbing subtitle track from the first time point to the second time point of the time progress of the dubbing subtitle track;
display in the editing interface a voice recognition text recognized from the voice clip; and
generate, based on a video editing completion operation, a fused video including the video, the voice clip, and the voice recognition text, wherein
the voice clip is playable with a video segment from the first time point to the second time point in the fused video, and
a subtitle of the voice clip in the fused video includes the voice recognition text.

14. The video editing apparatus according to claim 13, wherein the processing circuitry is configured to:
update the voice recognition text based on a text modification operation on the voice recognition text.

15. The video editing apparatus according to claim 14, wherein the text modification operation comprises one or more of a content modification operation, a style modification operation, a position modification operation, or an animation special effect editing operation.

16. The video editing apparatus according to claim 13, wherein the processing circuitry is configured to:
determine a target special effect when a special effect addition operation is performed on the visualized representation of the voice clip in the dubbing subtitle track;
perform voice change processing on the voice clip by using the target special effect, to obtain a voice-changed voice clip; and
replace the voice clip in the dubbing subtitle track with the voice-changed voice clip.

17. The video editing apparatus according to claim 13, wherein the processing circuitry is configured to:
update, when a movement operation is performed on the visualized representation of the voice clip in the dubbing subtitle track to move the visualized representation of the voice clip to an updated position with respect to the visualized representation of the dubbing subtitle track, a starting time point and an ending time point of the voice clip in the dubbing subtitle track based on the updated position.

18. The video editing apparatus according to claim 13, wherein
the editing interface further includes a preview playback region, a preview time progress of a preview operation in the preview playback region, the time progress of the video track, and the time progress of the dubbing subtitle track being based on a same timeline, and
the processing circuitry is configured to, when the preview time progress of the preview operation is at a preview time point between the first time point and the second time point:
play a video picture of the video at the preview time point in the preview playback region; and
display the voice recognition text on the video picture.

19. The video editing apparatus according to claim 13, wherein
the editing interface further includes a timeline and a pointer, the first time point corresponding to a position to which the pointer points on the timeline, and
the processing circuitry is configured to:
update the first time point based on a movement operation of the pointer on the timeline.

20. A non-transitory computer-readable storage medium storing instructions which, when executed by a processor, cause the processor to perform a video editing method comprising:
displaying, on a display, an editing interface, the editing interface including visualized representations of a video track and a dubbing subtitle track, a time progress of the video track being aligned with a time progress of the dubbing subtitle track, and the video track including a video;
starting recording of a voice clip when a dubbing start operation is triggered in association with a first time point of the time progress of the dubbing subtitle track;
stopping the recording of the voice clip when a dubbing end operation is triggered in association with a second time point of the time progress of the dubbing subtitle track;
loading the recorded voice clip into the dubbing subtitle track from the first time point to the second time point of the time progress of the dubbing subtitle track;
displaying in the editing interface a voice recognition text recognized from the voice clip; and
generating, based on a video editing completion operation, a fused video including the video, the voice clip, and the voice recognition text, wherein
the voice clip is playable with a video segment from the first time point to the second time point in the fused video, and
a subtitle of the voice clip in the fused video includes the voice recognition text usable.
